(19) United States
(12) Patent Application Publication
(10) Pub. No.: US 2010/0103874 A1
(43) Pub. Date: Apr. 29, 2010

(54) METHOD AND ARRANGEMENT, NODE AND ARTICLE FOR OPTIMIZED PS DOMAIN IN GAN

(76) Inventor: Jari Vikberg, Jarna (SE)

Correspondence Address: ERICSSON INC., 6300 LEGACY DRIVE, M/S EVR 1-C-11, PLANO, TX, 75024, US

(21) Appl. No.: 12/525,414

(22) PCT Filed: Feb. 6, 2007
(86) PCT No.: PCT/SE07/00105

§ 371 Date: Nov. 24, 2009

(51) Int. Cl. H04W 80/00

(52) U.S. Cl. 370/328

(57) ABSTRACT

A method and arrangement for optimizing a packet-switched (PS) domain of a Generic Access Network (GAN) that communicates with a Serving GPRS Support Node (SGSN) in the PS domain. The SGSN detects that a GAN access is being attempted by a mobile station. In response, communications between the mobile station and the SGSN are conducted using a light-weight version of a communication protocol in which functionality that is unnecessary in the GAN mode of operation is decreased.

### TECHNICAL FIELD

The present invention relates to methods and arrangement to optimize a Packet Switched PS domain of a Generic Access Network GAN in a communication system.

### BACKGROUND

Generic Access Network GAN is defined in 3GPP Technical Specifications 43.318 and 44.318 starting from 3GPP Release-6. The standards describe a telecommunication system GAN allowing seamless roaming and handover between local area network and wide area network. FIG. 1a in this patent application is part of the prior art and discloses a mobile terminal MS communicating with a Mobile Core Network MCN via either one of an Universal Terrestrial Radio Access Network UTRAN, a GSM Edge Radio Access Network GERAN, or a Generic Access Network GAN. The terminal further communicates via the MCN with any one of PLMN/Public Land Mobile Network, Internet, or PSTN/Public Switched Telephone Network.

FIG. 1b is also part of the prior art and discloses the PS domain parts of GAN functional architecture that are relevant for this patent application. The whole GAN functional architecture consists of more interfaces and nodes as defined in the 3GPP TS 43.318. FIG. 1b discloses the Mobile Station MS, a Generic IP Access Network GIPAN, a Security GateWay SEGW in a Generic Access Network Controller GANC also in this application referred to as a Controller GANC, and a Core Network CN comprising a Serving GPRS Support Node SGSN also referred to in this application as a Serving node SGSN. An Up-interface provides secure transmission, as an IP secure tunnel is established and used between the MS and the Security GateWay SEGW in the Generic Access Network Controller GANC. The Gb-interface is normally controlled by an operator and is also seen as secure. It might be desirable to provide security between the GANC and the SGSN in some network deployment scenarios. One example would be the case when the SGSN and the GANC reside in different parts of the network and are connected together using some public network. In this case it might be appropriate to provide some low-level security (e.g. secure IP tunnels) for the traffic between the GANC and the SGSN. In addition, the transmission in the Up-interface is based on broadband access networks (e.g. with one or more, up to tens of hundreds of Mbps ADSL/Asymmetric Digital Subscriber Line) and the use of high-speed unlicensed radio (e.g. with one or more, up to hundreds of Mbps WiFi/Wireless Fidelity). As such there are no clear transmission limits in the GIPAN between the GANC and the MS. A 2^{nd} Generation 2G Packet-Switched PS domain (aka GPRS) is based on the use of a Gb-interface between Radio Access Network RAN (e.g. a GANC in the GAN case or a Base Station Controller BSC in the GERAN case) and the SGSN (aka 2G-SGSN in this case). An Up-interface PS domain Control Plane Protocol Architecture and an Up-interface PS Domain User Plane Protocol Architecture are well known to those of skilled in the art and are described in the 3GPP TS 43.318. Below is disclosed, as a help to the reader to follow the coming description, the protocol architecture figures according to the standards for the Up-interface PS Domain Control Plane and for the Up-interface PS Domain User Plane Protocol:

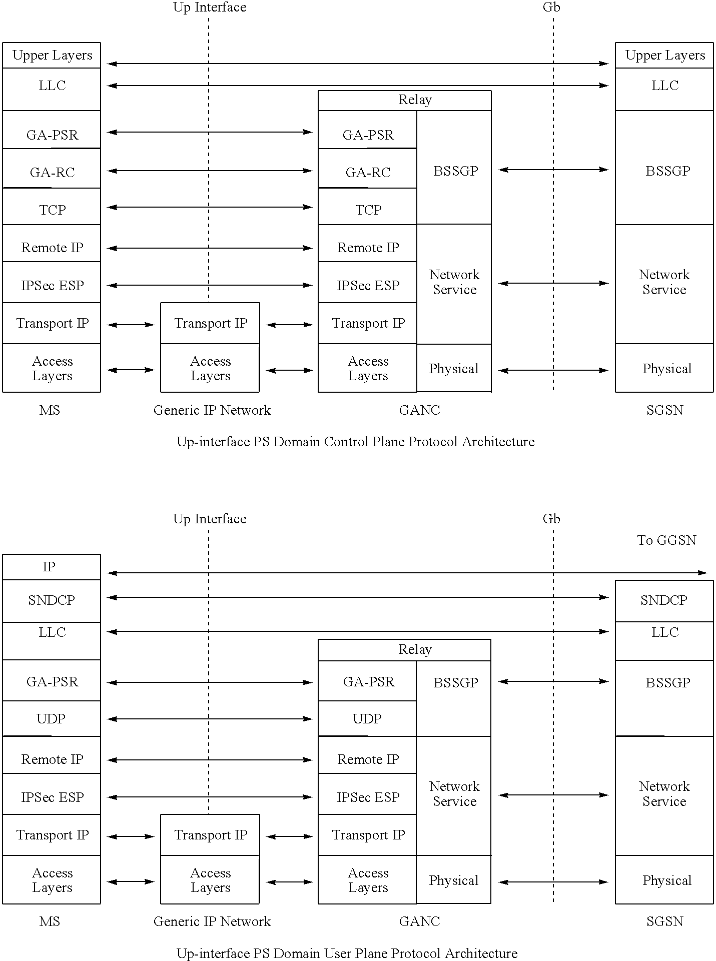

As can be seen in the standards, a Logical Link Control LLC layer is used in PS domain control plane for GAN between the MS and the SGSN. In addition, this layer is used exactly in the same way as in GSM/GPRS. As can also be seen in the standards, both a Logical Link Control LLC and a Subnetwork Dependent Convergence Protocol SNDCP layers are used in PS domain user plane for GAN between the MS and the SGSN. In addition, these layers are used exactly in the same way as in GSM/GPRS. The Gb-interface is used between the GANC and the SGSN. As part of the normal Gb-interface operations, the Base Station Subsystem GPRS Protocol BSSGP is used by the GANC to dynamically create BSSGP Virtual Connections BVC between the GANC and the SGSN. One Cell-BVC (also called Point-to-Point BVC i.e. PTP-BVC) is created for each cell and one or more additional node level (or really Network Service Entity NSE level as one node can have multiple NSEs defined) BVC called signaling-BVC is/are also created. The creation of the BVCs takes place as defined in 3GPP TS 48.018 using the BVC-RESET procedure. When a Cell-BVC is created, the GANC informs the SGSN of the Cell Global Identity CGI of the cell that the Cell-BVC is created for. Each BVC is identified with a BVC Identifier BVCI which is also signaled from the GANC to the SGSN. A CGI in GSM consists of a Location Area Identity LAI and a Cell Identity CI. Furthermore, the LAI consists of Mobile County Code MCC, Mobile Network Code MNC and Location Area Code LAC. The MCC and the MNC together build up the PLMN Identifier PLMN-ID which uniquely defines a mobile network. In addition, there is one more identifier called Routing Area Identity RAI that is built by the combination of LAI and Routing Area Code RAC. Both GSM cells and GAN cells are identified using a CGI and there is currently no known way for the SGSN to know if a specific CGI identifies a GSM or a GAN cell. The user plane is transmitted between the GANC and the SGSN using the UL-UNITDATA and DL-UNITDATA messages which are part of the BSSGP protocol. The UL-UNITDATA message is sent from the GANC to the SGSN and is used to carry one LLC Protocol Data Unit LLC-PDU. In addition, each UL-UNITDATA message includes also the CGI to indicate in which cell the MS is currently in. This means that the current cell of the MS is indicated towards the SGSN using two different ways: a) the BVCI defines a Cell-BVC which then relates to a CGI and b) the UL-UNITDATA message also contains the CGI.

A new work item has recently been approved in 3GPP TSG GERAN to investigate GAN enhancements. One of the main goals for this work is to optimize the GAN PS domain and mostly to optimize the user plane part of it. One proposal to optimize the GAN PS domain is to standardize generic access to an Iu-interface. The Iu-interface is the RAN-CN interface used in UMTS/WCDMA networks and the Iu-PS is the part used in the PS domain. Iu-PS has been optimized compared to the Gb-interface and if it would be specified that the GAN uses the Iu-interface towards the CN, then the PS domain would be also optimized. This would mean that the Up-interface changes and that new mobile stations MS would be needed. It would however be desirable to keep the Up interface unmodified and to support only changes that can be provided using the existing GAN standard.

### SUMMARY

The present invention relates to a problem how to optimize a Packet Switched domain in a GAN, while keeping the Up-interface unmodified. A further problem is related to identification of an access as being a GAN access.

The problems are solved by the invention by detecting that a GAN access is being used in a Serving GPRS Support Node SGSN and decreasing/minimising the functionality used on specified layers that are not necessary for the communication in the case GAN access is being used. The SGSN is made aware of that a GAN access is being used and, once this is the case, the Packet Switched domain is optimized in a way that would not be possible if another access, e.g. GERAN, was being used.

The solution more in detail comprises a method to optimize Packet Switched PS domain in a Generic Access Network GAN in a communication system wherein a Generic Access Network Controller GANC communicates with the SGSN in Packet Switched domain. The method comprises detection in the SGSN that GAN access is being used. Communication between the MS and the service node SGSN is then performed to activate a light-weight versions of the normally used protocols, so that functionality that is unnecessary in GAN mode of operation is turned off or minimized while GAN access is being used by the MS, while still securing transmission and high bandwidth.

In a first embodiment of the invention the GAN access detection is based on a pre-configuration of GAN network area information in the SGSN. The first embodiment comprises the following method steps:

The SGSN is pre-configured with information that identifies network areas representing the Generic Access Network GAN.

A Mobile Station/Subscriber MS enters into a network area representing the GAN. For example, a routing area update or a cell update (so called mobility management area updates) is triggered by the MS via the GANC and forwarded from the GANC to the SGSN.

The use of GAN access is determined in the SGSN by comparing information provided together with the forwarded routing area update or cell update, for example a CGI, a LAI or a RAI, with the pre-configured information.

In a second embodiment of the invention the GAN access detection is based on signaling enhancement between the

GANC and the SGSN. The second embodiment comprises the following method steps:

A BSSGP signaling between the controller GANC and the

SGSN is enhanced, when GAN access is being used, to include a GAN access indication.

An MS enters into a network area representing the GAN and for example, a routing area update or cell update is triggered by the MS via the GANC and forwarded from the GANC to the SGSN.

The access indication is sent of from the GANC to the SGSN together with the forwarded routing area update or cell update.

The use of GAN access is determined in the SGSN when the GAN access indication is received.

Alternatively, the GAN access indication can be included by the GANC when creating a Cell-BVC and by detecting in the SGSN that a Cell-BVC is used for which the GAN Access indication was included when the Cell-BVC was created.

In a third embodiment of the invention the GAN access detection is based on a combination of GANC and SGSN into one node. The third embodiment comprises the following method steps:

The GANC and the SGSN are combined into a combined node, Combined GANC/SGSN;

An MS enters into a network area representing the GAN.

A node internal GAN access indication message is used to indicate from the GANC part of the node to the SGSN part of the Combined GANC/SGSN node.

The use of GAN access is determined in the SGSN part of the Combined GANC/SGSN node when the node internal GAN access indication message is received.

The main object of invention is to make sure that the SGSN is aware of that GAN access is being used. Once this is the case, the SGSN can start using light-weight versions of e.g. the LLC and SNDCP protocols. The main issues are for example to turn off the ciphering on the LLC-layer and compression on the SNDCP-layer, taking into account the main features of the GAN Access (secure transmission and high bandwidth). This object and others are achieved by methods, arrangements, nodes, systems, and articles of manufacture.

An advantage with the invention is that the GAN PS domain can be optimized in a way that allows optimizations for the existing GAN terminals (i.e. the ones that apply to 3GPP GAN Rel-6 standard or to the UMA specifications).

Another advantage is that the SGSN will be able to simultaneously support a larger number of terminals. In addition, the MS doesn't need to perform complex operations (e.g. operations related to LLC-layer ciphering and/or SNDCP-layer compression) and the battery lifetime in the MS can be increased.

The invention will now be described more in detail with the aid of preferred embodiments in connection with the enclosed drawings.

### BRIEF DESCRIPTION OF THE DRAWINGS

FIG. 1a is part of the prior art and discloses a mobile terminal MS communicating with a Mobile Core Network MCN via either one of an Universal Terrestrial Radio Access Network UTRAN, a GSM Edge Radio Access Network GERAN, or a Generic Access Network GAN and further communicates to any one of PLMN/Public Land Mobile Network, Internet, or PSTN/Public Switched Telephone Network.

FIG. 1b is part of the prior art and discloses the PS domain parts of the GAN functional architecture that are relevant for this patent application.

FIG. 2 discloses a signal sequence diagram wherein the Serving GPRS Support Node SGSN is pre-configured with GAN access information for different network areas.

FIG. 3 discloses a signal sequence diagram wherein the GAN access detection is based on signaling enhancement between the GANC and the SGSN.

FIG. 4 discloses by a block schematic illustration, a system comprising a combined Generic Access Network Controller GANC and Serving GPRS Support Node SGSN.

FIG. 5 discloses a flow chart comprising some essential method steps of the invention.

FIG. 6 schematically discloses an arrangement that can be used to put the invention into practice.

### DETAILED DESCRIPTION

The basic invention consists of the following steps. First the SGSN is made aware of whether GAN access is being used for a particular Mobile Station/Subscriber MS. Secondly, when the SGSN finds out that GAN access is being used, the needed re-negotiations (e.g. GPRS Mobility Management GMM procedures and/or Logical Link Control LLC procedures and Subnetwork Dependent Convergence Protocol SNDCP XID parameter renegotiations) are triggered by the SGSN to optimize the transmission as long as GAN access is being used. When SGSN finds out that GAN access is not used anymore, the SGSN triggers the needed re-negotiations again to return to the normal mode of LLC and SNDCP operation. So while GAN access is being used, so called “light-weight versions” of the LLC- and SNDCP-protocols are being used. The LLC-layer ciphering can be turned off as GAN access is deemed as secure as the IP secure tunnel is used between the MS and the GANC-SEGW. The SNDCP-layer compression can be turned off as there are no clear transmission limits in the Up-interface between the MS and the GANC. In addition, other LLC and SNDCP XID parameters (as defined in 3GPP TS 44.064 and in 3GPP TS 44.065) could also be optimized for GAN mode of operation. These light-weight versions of the LLC and SNDCP protocols are supported already today by the existing terminals and the main idea is that all functionality that is unnecessary in GAN mode of operation is turned off while GAN access is being used.

The following description shows by three embodiments how the SGSN can be made aware of that GAN access is used. A description of the high-level steps for the needed GMM, SNDCP and LLC procedures then follows. As already stated in the prior art, both GSM cells and GAN cells are identified using a CGI and there is currently no known way for the SGSN to know if a specific CGI identifies a GSM or a GAN cell. The following three embodiments describe three separate ways to let the SGSN know that a particular cell is a GAN cell and then that an MS in that cell is using GAN access or to directly indicate that the MS is using GAN access.

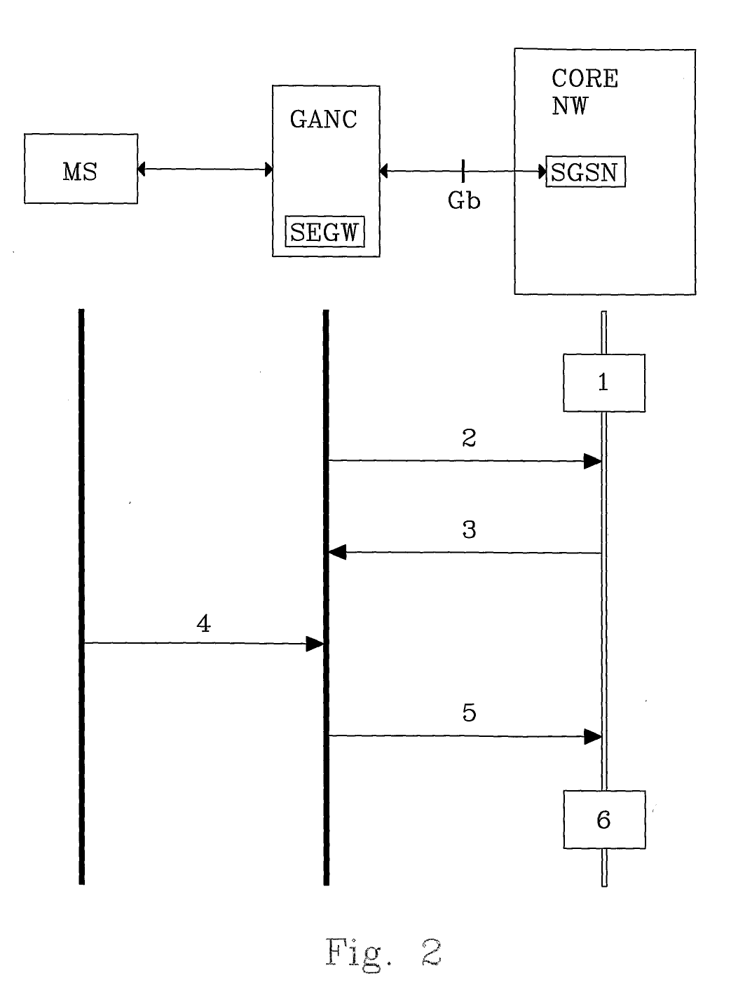

The first embodiment is disclosed in FIG. 2. In this approach, the SGSN is pre-configured with information about if a particular network area (cell identified with CGI, Location Area identified with LAI or Routing Area identified with RAI, etc.) is a GAN access. This means that either a number of Cells, Location Areas and/or Routing Areas are configured in the SGSN to be identified as GAN access. The main principle is that the Gb-interface signaling is kept unmodified and the needed logic is only added to the SGSN node. A method according to the first embodiment of the invention will now be explained more in detail. The explanation is to be read together with the earlier shown figures. The method comprises the following steps:

The SGSN is preconfigured 1 with information about cell, Location Area and/or Routing Area being GAN Access. The different areas are identified using the relevant identifiers (e.g. CGI, LAI or RAI). For example, the operator configures a list of CGI, LAI and/or RAI in a table in SGSN. The operator then defines which CGI/LAI/RAI that is to be used in GANC.

The GANC creates dynamically the Cell-BVC (BSSGP Virtual Connection) for GAN cell identified by e.g. CGI-1. This would happen e.g. when a GAN cell is defined in GANC. The GANC selects e.g. BVCI-X for the Cell-BVC to be created and sends the (BSSGP) BVC-RESET message 2 containing CGI-1 and BVCI-X to the SGSN. This step enables the SGSN to know that all traffic on BVCI-X is really coming from GAN cell identified with CGI-1.

The SGSN acknowledges 3 the creation of the Cell-BVC by returning the (BSSGP) BVC-RESET-ACK message to the GANC.

An MS enters the GAN coverage in the GAN cell identified by CGI-1 and performs normal GPRS Mobility Management procedures 4. This means that either a cell update or a Routing Area Update may be triggered.

The GANC forwards 5 e.g. the Routing Area Update towards the SGSN using Cell-BVC identified by BVCI-X. In addition, the (BSSGP) UL-UNITDATA message carries the CGI-1 in the message header.

The SGSN is able to determine 6 whether GAN access is being used. As CGI-1 has been defined as being a GAN cell, the SGSN knows that GAN access is being used and the SGSN can trigger the needed SNDCP and LLC XID reconfiguration procedures. In addition, the GMM Authentication and Ciphering procedure may be triggered to turn off ciphering.

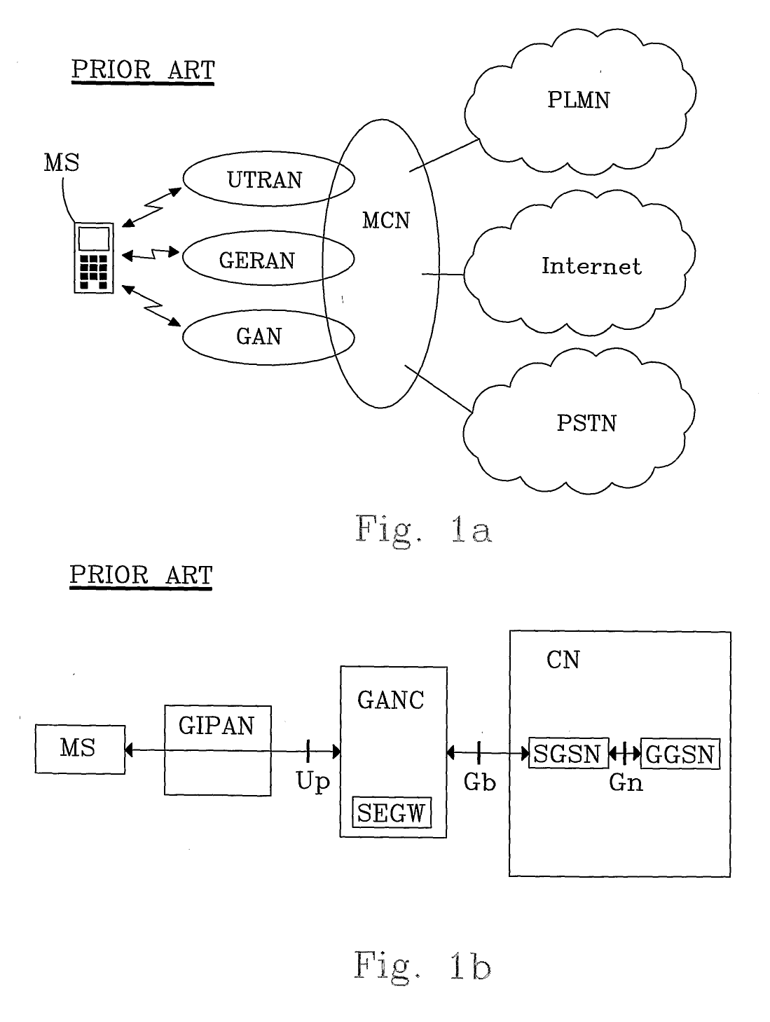

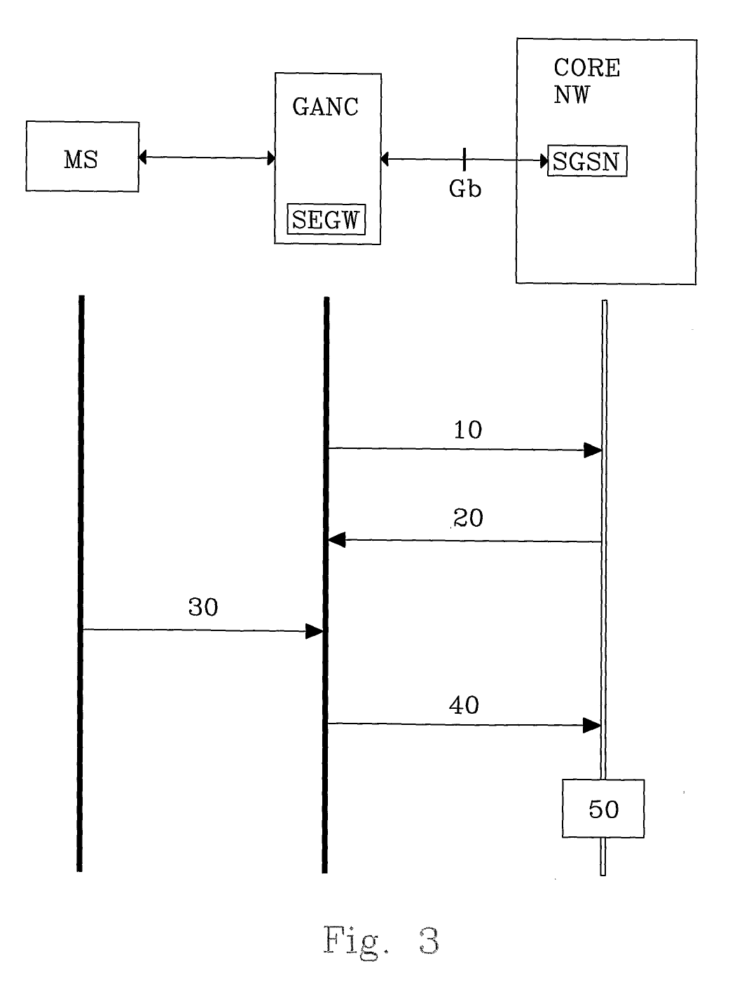

The second embodiment is disclosed in FIG. 3. In this approach, the GAN access detection is based on BSSGP signaling enhancement between the GANC and the SGSN. A method according to the second embodiment of the invention will now be explained more in detail. The explanation is to be read together with the earlier shown FIGS. 1a and 1b. The method comprises the following steps:

The BSSGP signaling between the GANC and the SGSN is enhanced to include a “GAN-Access” indication meaning that GAN access is being used. The GAN Access indication is in this example added to the (BSSGP) BVC-RESET message which is used by the GANC to create a Cell-BVC. Alternatively it can be added to an UL-UNITDATA message (see sequence with reference 40) or it can be added to both messages. As an example the following parameters “CGI-1; BVCI-X; GAN-ACCESS=yes” are sent from GANC to SGSN in the BVC-RESET message. If 10 has been sent with an indication that from now on all traffic from CGI-1/BVCI-X is coming from a GAN access, the sequence 40 does not have to be used to indicate GAN access.

The SGSN acknowledges 20 reception of the (BSSGP) BVC-RESET message by returning the (BSSGP) BVC-RESET-ACK message to the GANC.

An MS enters the GAN coverage in the GAN cell identified by CGI-1 and performs normal GPRS Mobility Management procedures 30. This means that either a cell update or a Routing Area Update may be triggered.

The GANC forwards the cell update or the Routing Area Update towards the SGSN using Cell-BVC identified by BVCI-X. In this example the following parameters “CGI-1; GAN-ACCESS=yes”; LLC-PDU=Routing Area Update or Cell Update” are sent 40 from GANC to SGSN in an UL-UNITDATA message. In addition, the use of BVCI-X is also indicated by the BSSGP layer in the SGSN. If the sequence 40 is sent as an indication of an ongoing GAN access, the sequence 10 must not have been used to indicate GAN access.

The SGSN is able to determine 50 that GAN access is being used when the GAN Access Indication “GAN-ACCESS=yes” is received. The SGSN triggers the needed SNDCP and LLC XID reconfiguration procedures. In addition, the GMM Authentication and Ciphering procedure may be triggered to turn off ciphering.

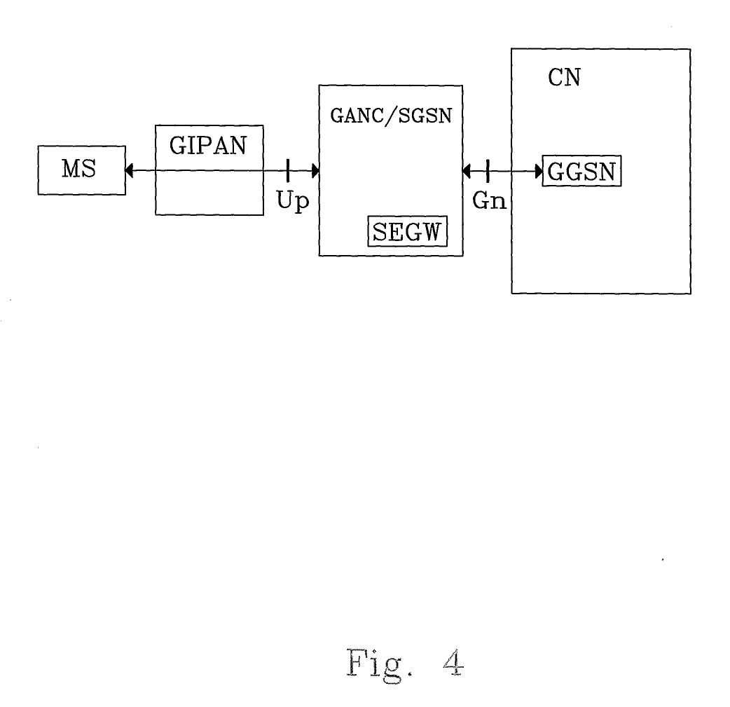

The third embodiment is disclosed in FIG. 4. In this approach the GANC and SGSN nodes (shown in FIG. 1b) are merged to one combined node GANC/SGSN. FIG. 4 shows the functional architecture for the Combined GANC/SGSN. As is shown, this combined node is connected to the GPRS Gateway Support Node GGSN using the Gn-interface. The main principle is that the GANC part of the Combined GANC/SGSN can inform the SGSN part using node internal signaling about GAN access being used. This is needed as the Combined GANC/SGSN can naturally also function as i) a 2G-SGSN with Gb-interfaces towards BSS(es) and/or ii) as 3G-SGSN with Iu-PS interfaces towards the RNS(es). Below is disclosed, as a help to the reader, the protocol architecture figures for the Up-interface PS Domain Control Plane Protocol Architecture and for the Up-interface PS Domain User Plane Protocol Architecture when the combined node GANC/SGSN is used. The Protocol architectures below are to compare with the earlier shown Protocol architectures according to the standards.

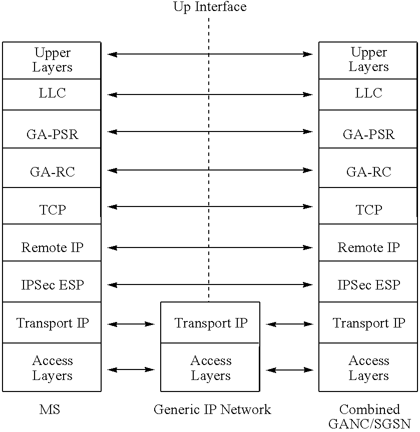

### Up PS Domain Control Plane Protocol Architecture For the Combined GANC/SGSN

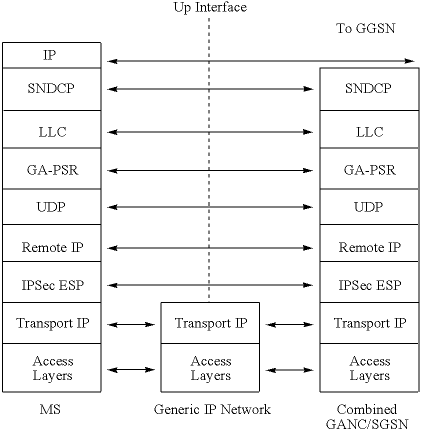

### Up PS Domain User Plane Protocol Architecture For the Combined GANC/SGSN

As an example on MS performing GPRS attach in GAN access, the SGSN finds out that GAN access is being used by using one of the three alternatives listed in the above described embodiments. Based on this, the SGSN signals to the MS to not use ciphering. The LLC and SNDCP XID parameters may also be renegotiated but these need normally be performed only in the case when there are also active PDP contexts. The related GPRS Mobility Management GMM, Subnetwork Dependent Convergence Protocol SNDCP and Logical Link Control LLC procedures will now be explained. The GMM Authentication and ciphering procedure is defined in 3GPP TS 24.008 and can be used to authenticate the MS and set the GSM ciphering mode (ciphering/no ciphering) and GSM ciphering algorithm. It is performed by the network sending a (GMM) AUTHENTICATION AND CIPHERING REQUEST message to the MS and the MS responding with a GMM AUTHENTICATION AND CIPHERING RESPONSE message. Whenever the MS is attached to GPRS it must be prepared to perform this procedure.

The basic principle is to use the GMM Authentication and ciphering procedure to set the ciphering mode to “no ciphering” while the MS is using a GAN access or when the MS enters GAN Access. When the MS leaves GAN access the opposite activation applies i.e. the ciphering mode can be set to “ciphering” if this is used in the other access i.e. an original mode of communication is again applied.

The SNDCP and LLC XID (re)negotiation procedures are defined in 3GPP TS 44.064 and 44.065. The main principle is that a specific set of operational parameters can be negotiated when e.g. a SNDCP- or LLC-layer connection is being established. In addition, either side may trigger renegotiation of the operational parameters at any time. The negotiation is normally performed by the SGSN sending a XID COMMAND message to the MS. This message is transmitted between the LLC protocol entities and is used to negotiate both LLC and SNDCP layer operational parameters. The SNDCP parameters can be negotiated e.g. whenever a PDP context is activated or modified.

The basic principle is to use the XID negotiation procedures to at least turn off the compression on SNDCP layer while the MS is using a GAN access with active PDP contexts (or when the MS enters GAN Access with active PDP contexts). When the MS leaves GAN access the opposite activation applies i.e. the compression can be activated again if this is used in the other access, e.g. in GERAN.

Both the above procedures can be triggered (at least) in the following scenarios:

GPRS attach in GAN access

PDP Context activation or modification in GAN Access

When the MS moves from GERAN/UTRAN to GAN and is already GPRS attached and performs Routing Area Update or Cell Update.

When the MS moves from GERAN/UTRAN to GAN with active PDP contexts.

When the MS moves from GAN to GERAN/UTRAN and is already GPRS attached and performs Routing Area Update or Cell Update.

When the MS moves from GAN to GERAN/UTRAN with active PDP contexts.

The above principles apply also for PS Handover (as defined in 3GPP TS 43.129). The target SGSN may either deactivate ciphering in the target cell (when performing PS HO towards GAN) or assign a GSM ciphering algorithm to be used in the target cell (when performing PS HO from GAN). In addition, the SNDCP XID parameters can be passed between the MS and target SGSN to activate or deactivate compression. The CGI of the target cell is signaled to the target SGSN and the pre-configuration of the SGSN embodiment could be used to find out that the target cell is a GAN cell. In addition, the GANC could also signal the GAN access indication in the PS HANDOVER REQUEST ACKNOWLEDGE message that is returned to the SGSN.

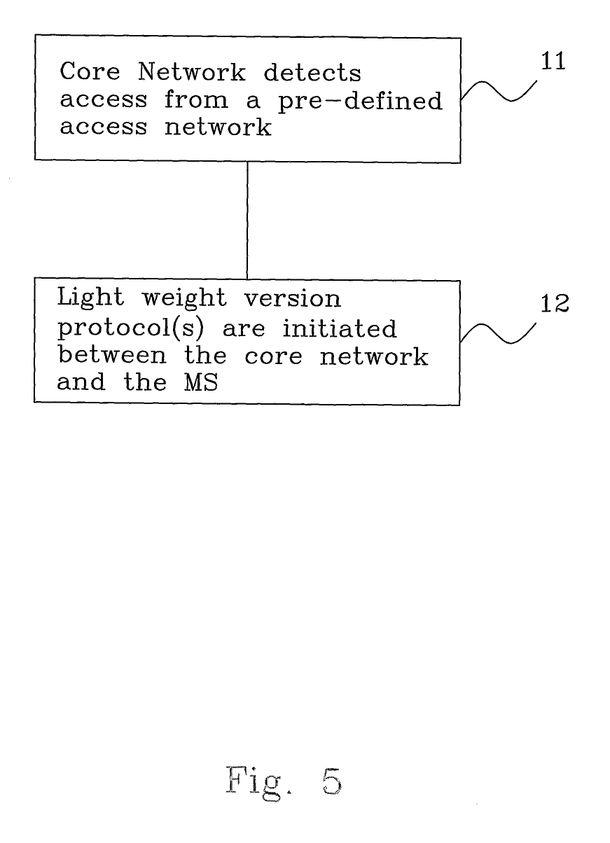

FIG. 5 discloses a flowchart in which some important steps of the invention are shown. The flowchart is to be read together with the earlier shown figures. The flow chart discloses optimization of the Packet Switched domain in an Access Network in a communication system wherein the access network communicates with a core network in Packet Switched domain. The flowchart comprises the following steps:
The core network detects that a defined access is being used. The detection can be performed using any one of the examples disclosed in the described embodiments. The GAN access detection is in one example based on a pre-configuration of the SGSN. In another example the GAN access detection can be based on BSSGP signaling enhancement between the GANC and the SGSN. Alternatively the GAN access detection can be based on a combination of GANC and SGSN into one node. To be noted is that these embodiments are just to be seen as examples. This step is shown in FIG. 5 with a block 11.
The core network initiates communication between the core network and the MS using one or more light-weight version protocol(s), so that functionality that is unnecessary for the present communication is turned off. This step is shown in FIG. 5 with a block 12.

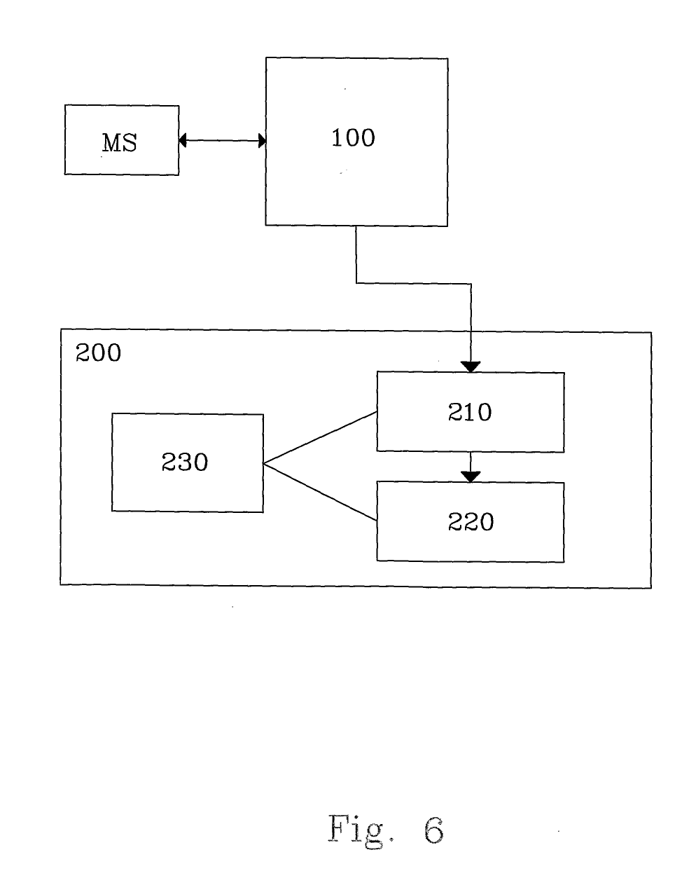

An example of an arrangement that can be used to put the invention into practice is schematically shown in FIG. 6. FIG. 6 discloses a mobile subscriber MS able to access an access network 100. The access network is attached to a core network 200. The core network comprises an access indicator 210. The access indicator 210 can either be a part of the core network 200 or it can be located outside the core network. The access indicator 210 comprises either means to pre-configure the SGSN with information that identifies network areas representing a specific type of access network. In another example the access indicator comprises means to enhance signaling between the GANC and the SGSN to include an indication when a specific type of access is being used. Alternatively the access indicator comprises means to combine GANC and SGSN into one node. To be noted is that these embodiments are to be seen just as examples. The access indicator 210 is attached to a Light Weight Version Indicator 220 able to initiate, upon access from defined network(s), compression and or removal of specified procedures that are unnecessary for the present access. In the figures enumerated items are shown as individual elements. In actual implementations of the invention, however, there may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is not limited to the above described and in the drawings shown embodiments. The systems and methods of the present invention may be implemented for example on any of the Third Generation Partnership Project (3GPP), European Telecommunications Standards Institute (ETSI), American National Standards Institute (ANSI) or other standard telecommunication network architecture. The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. Hence, the invention is not limited to the above described and in the drawings shown embodiments but can be modified within the scope of the enclosed claims.

1-19. (canceled)

20. A method of optimizing a packet switched domain of a Generic Access Network (GAN) that communicates with a Serving GPRS Support Node (SGSN) in the packet switched domain, the method comprising the steps of:
detecting in the SGSN that a GAN access is being used by a mobile station (MS); and
communicating between the MS and the SGSN utilizing a light-weight version of a communication protocol so that functionality that is unnecessary in a GAN mode of operation is decreased.

21. The method according to claim 20, wherein the communicating step includes communicating between the MS and the SGSN utilizing a light-weight version of a communication protocol selected from a Logical Link Control (LLC) protocol and a Subnetwork Dependent Convergence Protocol (SNDCP) protocol so that functionality that is unnecessary in a GAN mode of operation is decreased.

22. The method according to claim 20, wherein the MS communicates with the SGSN via a GAN Controller (GANC), and the detecting step includes:
pre-configuring the SGSN with information that identifies network areas representing the GAN;
moving by the MS into a network area representing the GAN, thereby triggering a cell update or a routing area update towards the GANC;
forwarding the cell update or the routing area update from the GANC to the SGSN; and
determining in the SGSN that the GAN access is being used by comparing information from the forwarded cell update or routing area update with the pre-configured information.

23. The method according to claim 20, wherein the MS communicates with the SGSN via a GAN Controller (GANG), and the detecting step includes:
enhancing Base Station System GPRS Protocol (BSSGP) signaling between the GANC and the SGSN to include an access indication when a GAN access is being used;
moving into a GAN area by the MS, thereby triggering a cell update or a routing area update towards the GANC;
sending a GAN access indication from the GANC to the SGSN; and
determining in the SGSN that GAN access is used, based on the access indication received.

24. The method according to claim 23, wherein the step of sending the GAN access indication to the SGSN includes sending the GAN access indication together with the cell update or the routing area update from the GANG to the SGSN.

25. The method according to claim 20, wherein the MS communicates with the SGSN via a GAN Controller (GANC), and the detecting step includes:
combining the GANG and the SGSN into a combined node (GANC/SGSN);
moving into a GAN area by the MS;
forwarding an internal GAN access indication message from the GANC part to the SGSN part of the combined GANC/SGSN; and
determining by the SGSN part that a GAN access is being used when the internal GAN access indication message is received.

26. The method according to claim 20, further comprising the steps of:
leaving the GAN area by the MS; and
changing from the light-weight version of the communication protocol to a standard version of the communication protocol.

27. An arrangement for optimizing a packet switched domain of a Generic Access Network (GAN) that communicates with a Serving GPRS Support Node (SGSN) in the packet switched domain, the arrangement comprising:
means for detecting in the SGSN that a GAN access is being used by a mobile station (MS); and
means for communicating between the MS and the SGSN utilizing a light-weight version of a communication protocol so that functionality that is unnecessary in a GAN mode of operation is decreased.

28. The arrangement according to claim 27, wherein the means for communicating includes means for communicating between the MS and the SGSN utilizing a light-weight version of a communication protocol selected from a Logical Link Control (LLC) protocol and a Subnetwork Dependent Convergence Protocol (SNDCP) protocol so that functionality that is unnecessary in a GAN mode of operation is decreased.

29. The arrangement according to claim 27, wherein the MS communicates with the SGSN via a GAN Controller (GANC), and the means for detecting includes:
means for pre-configuring the SGSN with information that identifies network areas representing the GAN;
means for triggering a cell update or a routing area update towards the GANC when the MS moves into a network area representing the GAN;
means for forwarding the cell update or the routing area update from the GANC to the SGSN; and
means for determining in the SGSN that the GAN access is being used by comparing information from the forwarded cell update or routing area update with the pre-configured information.

30. The arrangement according to claim 27, wherein the MS communicates with the SGSN via a GAN Controller (GANC), and the means for detecting includes:
means for enhancing Base Station System GPRS Protocol (BSSGP) signaling between the GANC and the SGSN to include an access indication when a GAN access is being used;
means for triggering a cell update or a routing area update towards the GANC when the MS moves into a GAN area;
means for sending a GAN access indication from the GANC to the SGSN; and
means for determining in the SGSN that GAN access is used, based on the access indication received.

31. The arrangement according to claim 30, wherein the means for sending the GAN access indication to the SGSN includes means for sending the GAN access indication together with the cell update or the routing area update from the GANC to the SGSN.

32. The arrangement according to claim 27, wherein the MS communicates with the SGSN via a GAN Controller (GANC) combined with the SGSN in a combined node (GANC/SGSN), and the means for detecting includes:
means for detecting that the MS has moved into a GAN area;
means for forwarding an internal GAN access indication message from the GANC part to the SGSN part of the combined GANC/SGSN; and
means for determining by the SGSN part that a GAN access is being used when the internal GAN access indication message is received.

33. The arrangement according to claim 27, wherein
means for detecting that the MS has left the GAN area; and
means for changing from the light-weight version of the communication protocol to a standard version of the communication protocol.

34. A network service node for optimizing a packet switched domain of a Generic Access Network (GAN) that communicates with the network service node in the packet switched domain, the network service node comprising:
means for detecting that a GAN access is being used by a mobile station (MS); and
means for communicating with the MS utilizing a light-weight version of a communication protocol so that functionality that is unnecessary in a GAN mode of operation is decreased.

35. The network service node according to claim 34, wherein the means for communicating includes means for communicating with the MS utilizing a light-weight version of a communication protocol selected from a Logical Link Control (LLC) protocol and a Subnetwork Dependent Convergence Protocol (SNDCP) protocol so that functionality that is unnecessary in a GAN mode of operation is decreased.

36. A combined node for optimizing a packet switched domain of a Generic Access Network (GAN), the combined node comprising:
a GAN Controller (GANC) part; and
a Serving GPRS Support Node (SGSN) part connected to the GANC part;
wherein the GANC part includes:
means for detecting when a mobile station (MS) has entered into the GAN; and
means for forwarding an internal GAN access indication message to the SGSN part of the combined node;
wherein the SGSN part includes:
means for determining that the MS is utilizing a GAN access based on the internal GAN access indication message.

37. An article of manufacture comprising a program storage medium having a computer readable program code embodied therein for optimizing a packet switched domain of a Generic Access Network (GAN) that communicates with a Serving GPRS Support Node (SGSN) in the packet switched domain, the computer readable program code comprising:
computer readable program code for detecting in the SGSN that a GAN access is being used by a mobile station (MS); and
computer readable program code for communicating between the MS and the SGSN utilizing a light-weight version of a communication protocol so that functionality that is unnecessary in a GAN mode of operation is decreased.

38. The article of manufacture according to claim 37, wherein the computer readable program code for communicating includes computer readable program code for communicating between the MS and the SGSN utilizing a light-weight version of a communication protocol selected from a Logical Link Control (LLC) protocol and a Subnetwork Dependent Convergence Protocol (SNDCP) protocol so that functionality that is unnecessary in a GAN mode of operation is decreased.
